(19) United States
(12) Patent Application Publication
(10) Pub. No.: US 2003/0184637 A1
(43) Pub. Date: Oct. 2, 2003

(54) Direct writing electrostatic image forming device

(76) Inventors: Samuel M. Lester, Boise, ID (US); Jimmy Sfaelos, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/113,444

(22) Filed: Mar. 29, 2002

(51) Int. Cl. G03G 15/00

(52) U.S. Cl. 347/129; 347/140; 399/159

(57) ABSTRACT

An image forming device that electrostatically writes directly to print media is disclosed. A printer, for example, includes an electrostatic imaging mechanism and a toner transfer mechanism. The electrostatic imaging mechanism writes an electrostatic image directly onto a print media. The toner transfer mechanism transfers toner onto the print media onto which the electrostatic image has been written.

### FIELD OF THE INVENTION

This invention relates generally to electrostatic image forming devices.

### BACKGROUND OF THE INVENTION

Laser printers have become very popular, especially where fast printer output is desired. Although other types of printers, such as inkjet printers, have become more popular for home use and for specialized tasks such as printing color output, laser printers are the mainstay of business users and other users that need fast, high-quality and usually black-and-white output. Other types of printers that operate on the same principle as laser printers, such as printers that utilize light-emitting diodes (LED's) instead of lasers, are also available and have become popular.

A laser printer generally works as follows. An image transfer roller, which may also be referred to as a photoreceptor drum, is pre-charged using a charged roller or corona wire. A laser then writes the desired image onto the image transfer roller. This means that the laser electrostatically discharges the image transfer roller according to the desired image. Meanwhile, a toner transfer roller is coated with charged toner from a toner hopper, or toner cartridge sump.

The toner is transferred onto print media in one of two ways. First, the print media may be fed between the image transfer roller and the toner transfer roller. The toner from the toner transfer roller is attracted to the electrically discharged points of the image transfer roller. Because the print media is being fed between these two rollers, the toner is transferred onto the print media, in the form of the desired electrostatically written image.

Second, the toner from the toner transfer roller, attracted to the electrically discharged points of the image transfer roller, may be transferred instead onto the image transfer roller in the form of the desired electrostatically written image. As the image transfer roller rolls over the print media, the print media pulls the toner from the roller. In either case, the print media is finally fed through a pair of fuser rollers to fuse the toner onto the print media so that the toner cannot be removed.

A disadvantage to such laser printers is that they generally have many moving parts that are more prone to failure than stationary parts. The abundance of moving parts also increases the cost of such laser printers. Furthermore, the image transfer roller and the toner transfer roller must be precisely aligned with one another to ensure that proper printing occurs on the print media. Ensuring such precise alignment is difficult, and may affect the reliability of the printer over its lifetime.

### SUMMARY OF THE INVENTION

The present invention relates to an image forming device that electrostatically writes directly to print media. An image forming device according to one embodiment of the present invention includes an electrostatic imaging mechanism to write an electrostatic image directly onto a print media, and a toner transfer mechanism to transfer toner onto the print media onto which the electrostatic image has been written. An image forming device according to another embodiment includes a charger to initially charge a print media, a writer to selectively discharge the print media, and a toner applicator to apply toner to the print media where the print media has been selectively discharged. Another embodiment according to the present invention includes a method of writing an electrostatic image directly onto a print media, and transferring toner onto the print media onto which the electrostatic image has been written.

An image forming device according to various embodiments of the present invention eliminates the need for an image transfer roller or photoreceptor drum. This is because embodiments of the invention electrostatically write a desired image directly onto the print media, instead of writing the desired image directly onto the image transfer roller. Eliminating the image transfer roller reduces manufacturing costs. Also precise alignment between the image transfer roller and the toner transfer roller is also eliminated, which may increase the long-term reliability of the printer.

### BRIEF DESCRIPTION OF THE DRAWINGS

FIG. 1 is a diagram of a laser printer that directly writes an electrostatic image onto a print media, according to an embodiment of the present invention.

FIG. 2 is a block diagram of a printer that directly writes an electrostatic image onto a print media, according to an embodiment of the present invention.

FIG. 3 is a flowchart of a method that includes directly writing an electrostatic image onto a print media, according to an embodiment of the present invention.

FIGS. 4A-4D are diagrams showing illustratively an example performance of the method of FIG. 3, according to an embodiment of the present invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced.

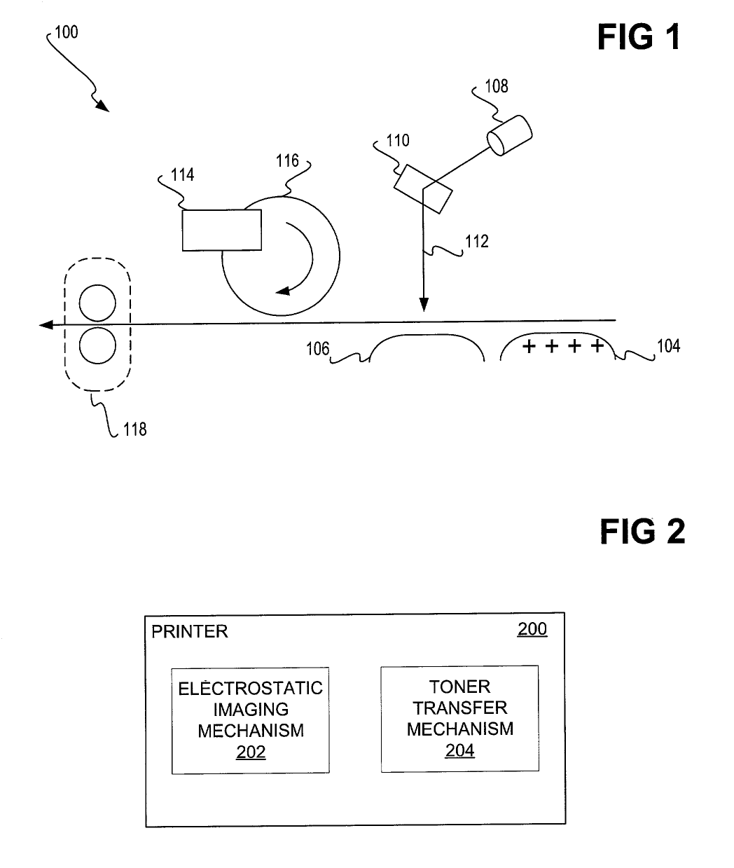

FIG. 1 shows an image forming device, such as the laser printer 100, according to an embodiment of the invention. A print media, such as paper, travels through the laser printer 100. When the print media passes over the charged mechanism 104, the charged mechanism 104 charges the entire surface of the print media. As shown in FIG. 1, the charged mechanism 104 may be a stationary charged plate. Alternatively, the charged mechanism 104 may be a charged rotating roller, or another type of charged mechanism. The print media next preferably passes over an electrically neutral and nonconductive mechanism 106 to reduce charge bleed-off from the print media. As shown in FIG. 1, the mechanism 106 may be an electrically neutral and nonconductive stationary plate. Alternatively, the mechanism 106 may be an electrically neutral and nonconductive roller, or another type of electrically neutral and nonconductive mechanism.

While the print media passes over the electrically neutral and nonconductive mechanism 106, a laser 108 writes a desired electrostatic image directly onto the print media via its laser beam 112. The laser beam 112 may be directed via a mirror 110. More specifically, the laser 108 selectively electrically discharges the previously charged print media according to a desired electrostatic image. The print media remains charged at all points except those conforming to the desired electrostatic image. The laser 108 is one type of writing mechanism that can be used to write the electrostatic image directly onto the print media. Other types of writing mechanisms can also be used, however, such as a number of light-emitting diodes (LED's), as well as other types of optical writing mechanisms that use light sources. Together with the electrically neutral and nonconductive mechanism 106 and the charged mechanism 104, the writing mechanism may be considered the electrostatic imaging mechanism that writes an electrostatic image directly onto the print media.

The print media next passes under a toner transfer roller 116. The toner transfer roller 116 is coated with electrically charged toner by rotating through a toner hopper 114, which may also be referred to as a toner cartridge sump. The toner transfer roller 116 is coated with this toner when the print media transfer under the toner transfer roller 116. The toner on the toner transfer roller 116 is electrically attracted only to those points of the print media that have been electrically discharged. The other points of the print media that remain electrically charged repel the similarly electrically charged toner on the toner transfer roller 116, and therefore do not attract the toner. As a result, the electrically charged toner is attracted to the print media from the toner transfer roller 116 in accordance with the desired image that has been electrostatically written on the print media.

The toner transfer roller 116 and the toner hopper 114 are more generally a toner transfer mechanism that transfers toner onto the print media as has been electrostatically written. Other types of toner transfer mechanisms may be utilized in lieu of the toner transfer roller 116 and/or the toner hopper 114. The print media finally passes through a pair of fuser rollers 118, which fuse the toner that has been selectively applied to the media. This ensures that the toner is permanently attached to the print media. Thus, in recap, a print media is first charged by passing over a charged mechanism 104. While the print media passes over an electrically neutral and nonconductive mechanism 106, a writing mechanism such as the laser 108 selectively electrically discharges the print media directly, in accordance with a desired image. While the print media next passes under a toner transfer roller 116, the media picks up the toner at those points that have been electrically discharged. The print media finally passes through the fuser rollers 118 to fuse the toner to the media.

FIG. 2 shows a block diagram of a printer 200 according to an embodiment of the invention. The printer 200 is more general than the printer 100 of FIG. 1, in the sense that the printer 100 of FIG. 1 can be considered a particular embodiment of the printer 200. The printer 200 specifically includes an electrostatic imaging mechanism 202 and a toner transfer mechanism 204. The electrostatic imaging mechanism 202 writes an electrostatic image directly onto a print media, whereas the toner transfer mechanism 204 transfers toner onto the print media after the electrostatic image has been written directly onto the media.

The electrostatic imaging mechanism 202 preferably includes a charged mechanism, or charger, to charge the print media, and a writing mechanism, or writer, to write the electrostatic image directly onto the print media. For instance, the charged mechanism may be a stationary charged plate or a charged roller, whereas the writing mechanism may be a laser or a number of LED's, for example. The electrostatic imaging mechanism 202 may also include an electrically neutral and nonconductive mechanism over which the print media passes while the writing mechanism writes the electrostatic image directly onto the print media.

The toner transfer mechanism 204, which may also be referred to as a toner applicator, may include a toner hopper and a toner transfer roller. The toner hopper stores the charged toner, whereas the toner transfer roller rotates through the hopper to coat itself with toner, and then passes by the print media so that the toner is selectively attracted to the print media. Finally, the electrostatic imaging mechanism 202 may be considered as or may be considered to include means for writing the electrostatic image directly onto the print media. Similarly, the toner transfer mechanism 204 may be considered as or may be considered to include means for transferring the toner onto the print media onto which the electrostatic image has been written.

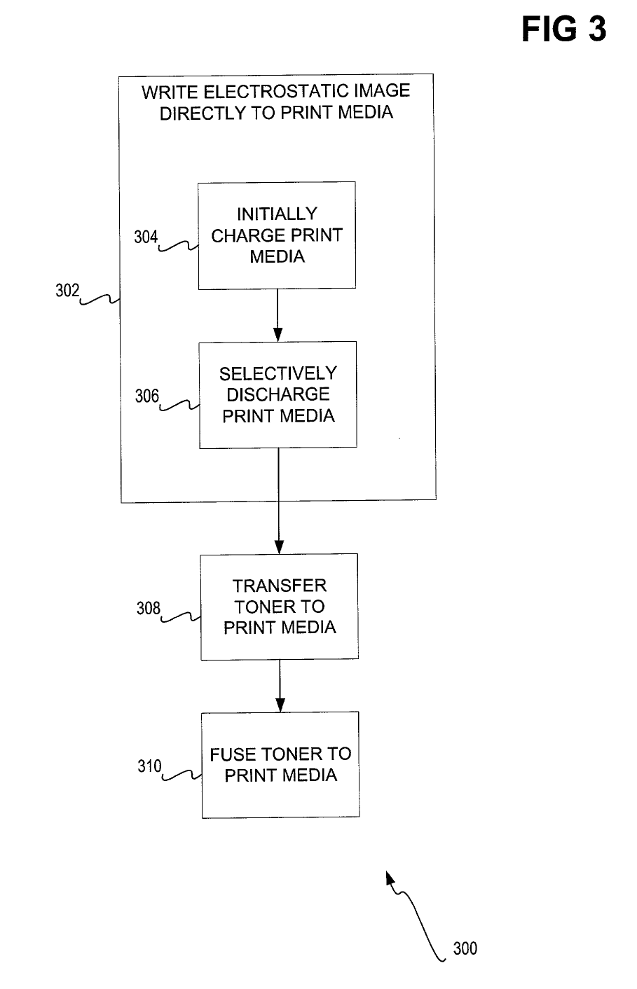

FIG. 3 shows a method 300 according to an embodiment of the invention. The method 300 is performed by a printer or other image forming device, such as one of the printers 100 and 200 of FIGS. 1 and 2, respectively, previously described. First, an electrostatic image is written directly to print media (302). This includes initially charging the print media (304), and then selectively discharging the print media (306) in accordance with the desired image. Toner is next transferred to the print media (308), and is specifically applied to the points of the print media that have been selectively discharged. Finally, the toner is fused to the print media (310).

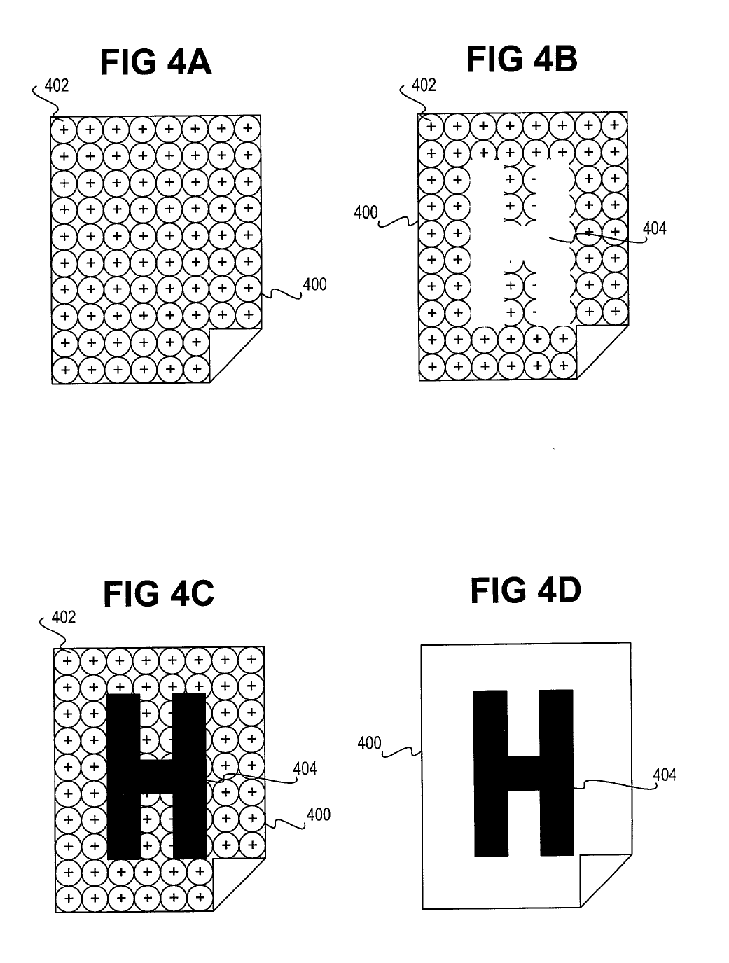

FIGS. 4A-4D illustratively show an example performance of the method 300 of FIG. 3, according to an embodiment of the invention. In FIG. 4A, a print media 400 has been initially charged. This is specifically indicated by the presence of positive charges, such as the positive charge 402, over the entire surface of the print media 400. In FIG. 4B, the print media 400 has been selectively discharged in accordance with a desired image 404. The desired image 404 is specifically the letter “H”. Thus, the positive charges, such as the positive charge 402, remain over the surface of the print media 400, except where the print media 400 has been discharged.

In FIG. 4C, toner has been selectively applied to surface of the print media 400, specifically to the points of the print media 400 that have been discharged. This is indicated by the shading of the electrostatically discharged image 404. That is, electrically charged toner is attracted only to the points of the print media 400 that have been discharged. The points of the print media 400 that remain charged, as indicated by the presence of positive charges, such as the positive charge 402, repel the electrically charged toner, and thus the toner is not attracted to these parts of the print media 400. Finally, in FIG. 4D, the toner that has been transferred to the electrically discharged image 404 of the print media 400 is fused to the print media 400.

It is noted that, although specific embodiments have been illustrated and described herein, it will be appreciated by those of ordinary skill in the art that any arrangement is calculated to achieve the same purpose may be substituted for the specific embodiments shown. For example, although the various embodiments described herein have been with reference to a laser printer, any suitable image forming device may be used. This application is intended to cover any adaptations or variations of the present invention. Therefore, it is manifestly intended that the scope of the present invention be limited only by the claims and equivalents thereof.

We claim:

1. An image forming device comprising:
an electrostatic imaging mechanism to write an electrostatic image directly onto a print media; and,
a toner transfer mechanism to transfer toner onto the print media onto which the electrostatic image has been written.

2. The image forming device of claim 1, wherein the electrostatic imaging mechanism comprises:
a charged mechanism to charge the print media; and,
a writing mechanism to write the electrostatic image directly onto the charged print media.

3. The image forming device of claim 2, wherein the charged mechanism comprises a stationary charged plate.

4. The image forming device of claim 2, wherein the charged mechanism comprises a charged roller.

5. The image forming device of claim 2, wherein the writing mechanism comprises a laser.

6. The image forming device of claim 2, wherein the writing mechanism comprises a plurality of light-emitting diodes (LED's).

7. The image forming device of claim 2, where the electrostatic imaging mechanism further comprises an electrically neutral and nonconductive mechanism over which the print media passes while the writing mechanism writes the electrostatic image to the print media.

8. The image forming device of claim 7, wherein the electrically neutral and nonconductive mechanism comprises one of an electrically neutral and nonconductive stationary plate and an electrically neutral and nonconductive roller.

9. The image forming device of claim 1, wherein the toner transfer mechanism comprises:
a toner hopper filled with charged toner; and,
a toner transfer roller rotatable through the toner hopper for coating with the charged toner.

10. The image forming device of claim 1, wherein the electrostatic imaging mechanism comprises means for writing the electrostatic image directly onto the print media.

11. The image forming device of claim 1, wherein the toner transfer mechanism comprises means for transferring the toner onto the print media onto which the electrostatic image has been written.

12. A printer comprising:
a charger to initially charge a print media;
a writer to selectively discharge the print media; and,
a toner applicator to apply toner to the print media where the print media has been selectively discharged.

13. The printer of claim 12, where the print media has a path starting at the charger, proceeding next past the writer, and proceeding thereafter past the toner applicator.

14. The printer of claim 12, further comprising an electrically neutral and nonconductive mechanism against which the writer selectively discharges the print media.

15. The printer of claim 14, wherein the electrically neutral and nonconductive mechanism comprises one of an electrically neutral and nonconductive stationary plate and an electrically neutral and nonconductive roller.

16. The printer of claim 12, wherein the charger comprises one of a stationary charged plate and a charged roller.

17. The printer of claim 12, wherein writer comprises one of a laser and a plurality of light-emitting diodes (LED's).

18. A method comprising:
writing an electrostatic image directly onto a print media; and,
transferring toner onto the print media onto which the electrostatic image has been written.

19. The method of claim 18, wherein writing the electrostatic image directly onto the print media comprises:
initially charging the print media; and,
selectively discharging the print media.

20. The method of claim 19, wherein transferring the toner onto the print media onto which the electrostatic image has been written comprises applying toner to the print media where the print media has been selectively discharged.
